(19) United States
(12) Patent Application Publication
(10) Pub. No.: US 2012/0259712 A1
(43) Pub. Date: Oct. 11, 2012

(54) ADVERTISING IN A VIRTUAL ENVIRONMENT

(75) Inventors: Arn HYNDMAN, Ottawa (CA); Nicholas SAURIOL, Ottawa (CA); Gordon Frederick WALLS, Nepean (CA)

(73) Assignee: Avaya Inc., Basking Ridge, NJ (US)

(21) Appl. No.: 13/081,070

(22) Filed: Apr. 6, 2011

(51) Int. Cl. G06Q 30/00

(52) U.S. Cl. 705/14.73

(57) ABSTRACT

A method and system for placing advertising content in a three-dimensional virtual environment. A predefined space is selected for receiving the advertising content from an advertising provider. Information regarding the context of the space within the virtual environment is used by the advertising provider to select appropriate advertising content that relates to the context of the space within the virtual environment where the advertising content is to be placed. The advertising content can be content already existing on an advertisement server. The advertising content can change and alternate content can be substituted for the original content upon the occurrence of certain events.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to virtual environments and more specifically to a method and system for providing advertisements within a three-dimensional virtual environment.

### BACKGROUND OF THE INVENTION

A virtual environment is typically a multi-dimensional computer simulated environment that is used to facilitate interaction between one or more participants. In operation, the virtual environment participant runs a virtual environment client on a computing device that communicates with a virtual environment server over a computer network, such as a local area network or wide area network. Interaction between one or more virtual environment participants in the virtual environment may be facilitated by avatars, which are characters representing the participants. Each participant in the virtual environment has their own avatar and may customize its appearance to their choosing by selecting from various hairstyles, outfits, skin tones, gender, facial features and the like. Movements and interaction of an avatar in the virtual environment is controlled by the corresponding participant by using a combination of input/output devices such as a computer mouse, keyboard, audio headset and microphone. Context in which virtual environments may be used include single or multi-player gaming, although other uses for virtual environments are being developed. For example, virtual environments are being used to simulate real life environments that enable online education, training, shopping and other types of interactions between groups of users, between businesses and users, and between businesses.

In the business context, advertisers have realized the enormous potential benefits of placing advertisements within the virtual environment. Typically, a three-dimensional virtual environment hosted by one entity incorporates advertising material supplied by another entity. The advertising material may consist of interactive two dimensional and/or three-dimensional objects. If the three-dimensional web host is to be successful, it must provide mechanisms to support all types of advertising. However, to date, only limited means of advertising in the three-dimensional worlds exist and these means are incompatible with popular existing advertising programs.

One type of less successful advertising mechanism is a static or “baked in” form of advertising. Static advertising, frequently used in games, essentially places product advertisements within the game, similar to the advertising in television shows and in movies. Attempts at static advertising within the three-dimensional world have been generally unsuccessful because once created these static advertisements cannot be changed or updated, and therefore become outdated and irrelevant over time. In a virtual world that is being used for several years, this is an enormous problem.

Dynamic-type advertising is also being used. This type of advertising is a two dimensional texture that is supplied over the Internet from an advertising server. This type of attempted solution has also been unsuccessful because it is in essence proprietary. That is, it typically requires a custom interface and permission from the advertising agency. Further, the implementer of the 3D virtual environment must include libraries from a specific advertising supplier or implement the interface from a specific advertising supplier, which may be costly. There are also only a limited number of smaller advertising suppliers available for 3D virtual environments. This reduces the potential advertisement revenue and reduces the likelihood that the advertisements are properly targeted and/or appropriate for the audience. As a result, it is difficult for a small-content based enterprise to receive advertising revenue.

Other attempted solutions are not able to provide detailed three-dimensional interactive advertisements within a three-dimensional (“3D”) virtual environment. Typically, web-based advertising involves the insertion of a Javascript® function provided by an advertising content server within a website host's web page. The Javascript® function may collect data about the web page and the current user such as the user's IP address, language, and the content of the rest of the web page (alternatively page content data may be collected by search engine crawling of the web page). This information assists the advertisement server in deploying appropriately targeted advertising. However, this type of advertisement placement doesn't work with virtual environments. A virtual environment is not described with HTML, so the search engine/Javascript®cannot collect the data it needs and cannot insert the advertisement as an html snippet.

Therefore, what is needed is an efficient technique for providing effective advertising content within an interactive 3D virtual environment.

### SUMMARY OF THE INVENTION

The present invention advantageously provides a method and system for placing advertising content in a three-dimensional virtual environment. A predefined space is selected for receiving the advertising content from an advertising provider. Information regarding the context of the space within the virtual environment is used by the advertising provider to select appropriate advertising content that relates to the context of the space within the virtual environment where the advertising content is to be placed. The advertising content can be content already existing on an advertisement server. The advertising content can change and alternate content can be substituted for the original content upon the occurrence of certain events.

According to one aspect of the invention, a method for placing an advertisement in a virtual environment where the virtual environment contains a predefined space to receive the advertisement is provided. The method includes retrieving a web-based advertisement from an advertisement server, inserting the advertisement within a trivial document, and rendering the trivial document within the predefined space of the virtual environment.

According to another aspect, a system for placing a two-dimensional advertisement in a three-dimensional virtual environment is provided. The system includes a three-dimensional (3D) virtual environment engine adapted to define a space within the virtual environment to receive the advertisement, the advertisement being stored on an advertisement server. The 3D virtual environment engine is also adapted to retrieve a web-based advertisement and insert the advertisement within a trivial document. The system also includes a 3D web renderer for rendering the trivial document containing the advertisement within the predefined space of the virtual environment.

According to yet another aspect of the invention, a method for placing first three-dimensional (3D) advertising content in a three-dimensional virtual environment is provided. The method includes allocating a 3D space within the virtual environment to receive the first advertising content, retrieving a script from an advertising provider, the script determining a context of the 3D space, receiving the first advertising content from the advertising provider, the first advertising content corresponding to the context of the 3D space, and rendering the first advertising content within the 3D space.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary system of the present invention showing how client devices interact with a virtual environment that provides three-dimensional advertisements;

FIG. 2 is a flowchart illustrating how a two-dimensional advertisement is rendered within a three-dimensional virtual environment performed by an embodiment of the present invention;

FIG. 3 is a block diagram showing how interactive two-dimensional advertising within the virtual environment of the present invention is backwards compatible with existing web advertising; and

FIG. 4 is a block diagram showing how three-dimensional advertisements are placed within a three-dimensional virtual environment in accordance with the principles of the present invention.

### DETAILED DESCRIPTION OF THE INVENTION

Before describing in detail exemplary embodiments that are in accordance with the present invention, it is noted that the embodiments reside primarily in combinations of apparatus components and processing steps related to implementing a system and method for providing advertising content in a three-dimensional virtual world environment.

As used herein, relational terms, such as “first” and “second,” “top” and “bottom,” and the like, may be used solely to distinguish one entity or element from another entity or element without necessarily requiring or implying any physical or logical relationship or order between such entities or elements.

One embodiment of the present invention advantageously provides a method and system for placing two-dimensional or three-dimensional advertising content in a three-dimensional virtual environment. A predefined space is selected for receiving the advertising content from an advertising provider. Information regarding the context of the space within the virtual environment is used by the advertising provider to select appropriate advertising content that relates to the context of the space within the virtual environment where the advertising content is to be placed. Certain elements of the advertising content are made active upon the occurrence of certain events like the advertisement appearing in the user's point-of-view, when the user clicks their mouse cursor on the advertisement or when certain events within the virtual environment occur such as the appearance of an avatar. The advertising content can also change and alternate content can be substituted for the original content upon the occurrence of certain events.

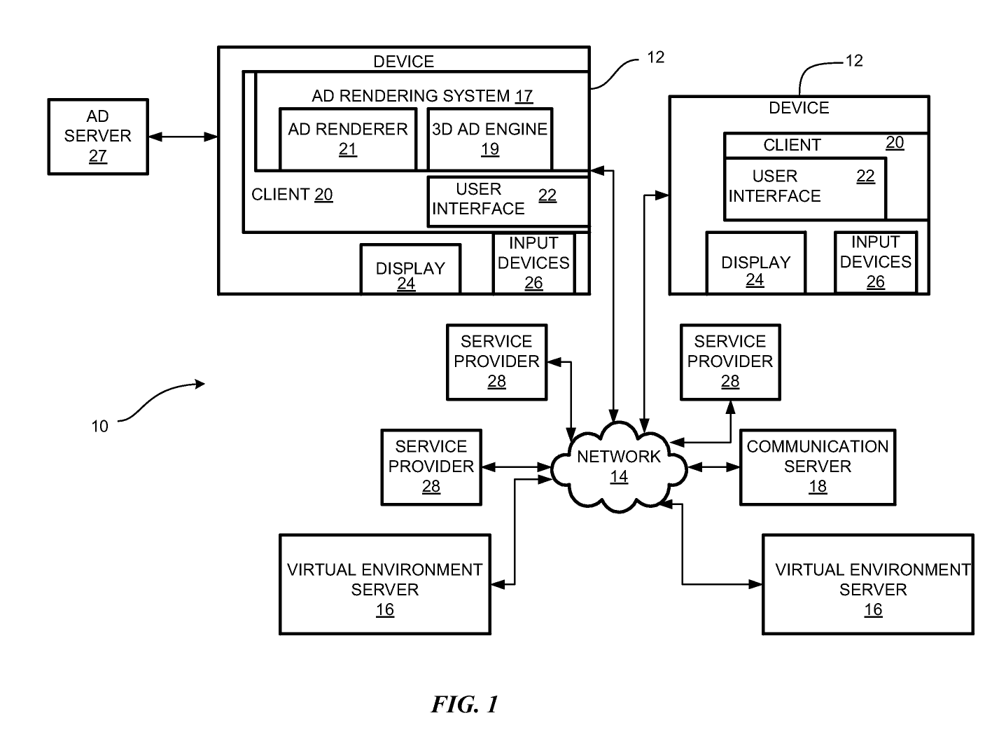

Referring now to the drawing figures in which like reference designators refer to like elements, there is shown in FIG. 1 an exemplary system 10 showing the interaction between a plurality of users of computing devices 12 and one or more three dimensional (“3D”) virtual environments. A user may access the virtual environment from their computing device 12 over a packet network 14 or other common communication infrastructure. Communication sessions such as audio calls between the users of the computing devices 12 may be implemented by one or more communication servers 18.

Interaction between virtual environment users in the virtual environment is facilitated by avatars, which are characters representing the users. Each user in the virtual environment has their own avatar and may customize its appearance to their choosing by selecting from various hairstyles, outfits, skin tones, gender, facial features and the like. Movements and interaction of an avatar in the virtual environment is controlled by the corresponding user by using a combination of input/output devices such as a computer mouse, keyboard, audio headset and microphone.

The virtual environment may be hosted by one or more virtual environment servers 16. Avatars representing users may move within the 3D coordinate space of the virtual environment and interact with objects and other avatars within the 3D coordinate space. Virtual environment servers 16 maintain the virtual environment and generate a visual presentation for each user based on the location of the user's avatar within the virtual environment. The view may also depend on the direction in which the avatar is facing and the selected viewing option, such as whether the user has opted to have the view appear as if the user was looking through the eyes of the avatar, or whether the user has opted to pan back from the avatar to see a three dimensional view of where the avatar is located and what the avatar is doing in the three dimensional computer-generated virtual environment.

System 10 also includes an advertisement rendering system 17, discussed in greater detail below. Advertisement rendering system 17 can be located within a virtual environment client 20 and is in communication with virtual environment server 16 via network 14. Advertisement rendering system 17 includes a 3D advertisement engine 19, which defines space within a 3D virtual environment for a 2D advertisement. The term “advertisement” in the context of this application does not imply that the invention is limited purely to “advertisements”. As used herein, the term “advertisement” means any content delivered by an advertisement server. Advertisement rendering system 17 also includes an interactive 3D ad renderer 21, which renders two dimensional (“2D”) advertising content in the 3D virtual environment. Advertising content is obtained from an advertisement server 27.

Each user has a computing device 12 that may be used to access the multi-dimensional computer-generated virtual environment. Computing device 12 runs a virtual environment client 20 and a user interface 22 to the virtual environment. Notably, virtual environment client 20 may be a stand-alone software package or may alternatively be a thin client that simply requires the use of an Internet web browser and an optional browser plug-in. A separate virtual environment client 20 may be required for each virtual environment that the user would like to access, although a particular virtual environment client 20 may be designed to interface with multiple virtual environment servers 16. The virtual environment client also enables the user to communicate with other users who are also participating in the multi-dimensional computer-generated virtual environment. The communication portion of the client may be a separate process running on user interface 22. Computing device 12, virtual environment servers 16 and communication servers 18 each include CPUs, memory, volatile/non-volatile storage, communication interfaces and hardware and software peripherals to enable each to communicate with each other across network 14 and to perform the functions described herein.

The user may see a representation of a portion of the multi-dimensional computer-generated virtual environment on a display 24 and input commands via a user input device 26 such as a mouse, touch pad, or keyboard. Display 24 may be used by the user to transmit/receive audio information while engaged in the virtual environment. For example, display 24 may be a display screen having a speaker and a microphone. The user interface generates the output shown on display 24 under the control of virtual environment client 20, and receives the input from the user via user input device 26 and passes the user input to the virtual environment client 20. Virtual environment client 20 passes the user input to virtual environment server 16 which causes the user's avatar or other object under the control of the user to execute the desired action in the virtual environment. In this way, the user may control a portion of the virtual environment, such as the person's avatar or other objects in contact with the avatar, to change the virtual environment for the other users of the virtual environment.

It is often desirable to insert advertisements within a virtual environment. However, many virtual environments utilize “baked in” or static advertisements that will eventually become obsolete. The present invention utilizes advertisements already in existence and, which could be provided by third party advertisers. The present invention advantageously provides three different types of advertising in a 3D virtual environment. In one embodiment, a 2D web advertisement is mapped to a 3D surface. In a second embodiment, a 3D web advertisement is mapped to a 3D surface similar to a window into the advertisement. The third embodiment is a full 3D object insertion into the 3D virtual environment. The first 2 embodiments are transparent to the advertiser and the advertising agency. The 3^{rd} embodiment (full 3D object insertion) may require the advertiser and the advertising agency to make some changes but is designed to follow the same pattern as currently used.

Referring to the first embodiment, a 2D advertisement is retrieved by ad rendering system 17. The advertisement can be in the form of a page or document in, for example, hyper text markup language (“HTML”) and stored on, for example, a third party advertising server (not shown in FIG. 1). The advertisement document is placed within a trivial HTML document, i.e., a basic document with very little content and few tags. In one embodiment, the trivial HTML document is enhanced with tags derived from a 3D environment in order to provide proper context for the advertisement server. In this fashion, the advertisement content retrieved from the advertisement server is adapted and relates to the context of the 3D environment. For example, if one scene is an interactive 3D video game includes a car chase, an advertisement for a particular brand of automobiles can be obtained from an advertisement server and situated in the scene. The trivial HTML document can be constructed such that it includes text that relates to the 3D environment, such as cars, car racing, etc. This allows the advertising service to extract this data from the HTML document in order to supply appropriate advertisements, such as, for example, for different car brands and styles or for motor oil and/or car parts.

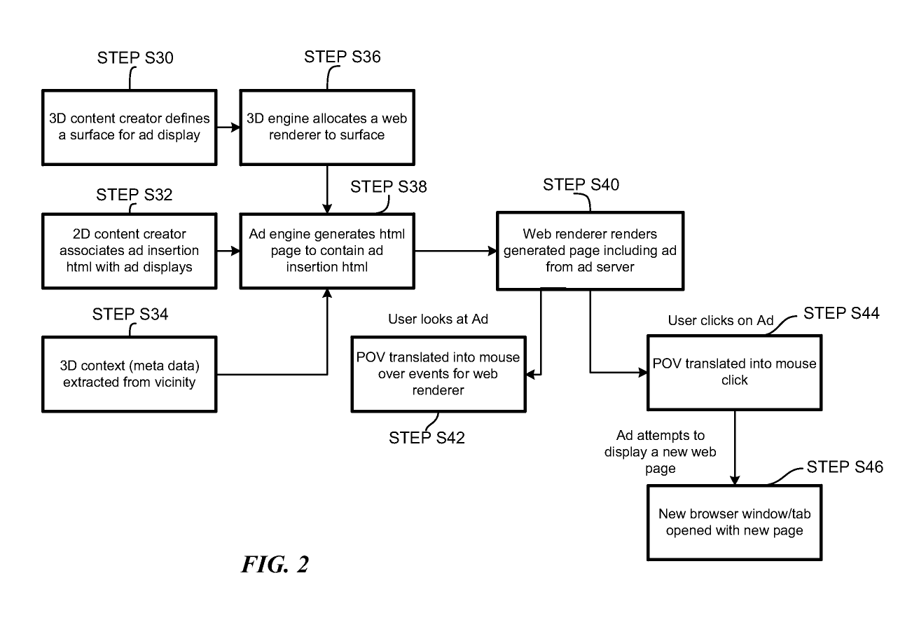

The HTML advertisement document, which represents a 2D surface in the 3D environment, is rendered by interactive 3D ad renderer 21. The steps taken by the present invention to render 2D advertising that is backward compatible with existing web advertising in the 3D virtual environment are shown in FIG. 2. Initially, a surface space for a 2D advertisement is defined by 3D ad engine 19 within the 3D virtual environment (step S30). This can be accomplished by texture mapping, a process whereby a content creator describes how 2D textures or other 2D materials are mapped onto a 3D object. As part of the mapping process, the content creator defines what content should be mapped. The content creator indicates that an advertisement is to be mapped onto a 3D object. The present invention creates an HTML document and renders the page into a buffer that is then converted into a texture and rendered by the 3D graphics engine onto the 3D object. Thus, in one embodiment, prior to the actual hosting of the 3D environment, a set up process occurs where the virtual environment is defined and the locations of the advertisements are chosen. Then, during actual runtime, the virtual environment is run and advertisements are displayed.

The 2D advertisement can be, for example, an advertisement that is already in existence on an advertisement server such as those provided by Google®. The HTML document containing the advertisement is associated with the surface created for the advertisement display, (step S32). This is accomplished, in one embodiment, as follows. An advertising content provider indicates that it wants to target certain users by their advertisements. This is accomplished by specifying key words. Each page that embeds the advertiser's Javascript® tries to find the specified keywords. Upon doing so, the advertiser's content is delivered to that page. By populating the HTML document with information from the virtual world, the appropriate content can be delivered by recognizing the key words. Virtual environment server 16 extracts any 3D context data, i.e., metadata, within the 3D environment, at step S34. The process of extracting data from the virtual environment can take place on virtual world client 20 or virtual environment server 16. Rendering the HTML document containing the metadata can be performed on virtual world client 20 to preserve client specifics, i.e., language, IP address, location, and time of day.

Metadata can be extracted from intrinsic properties of the 3D environment in a number of ways. The metadata can include volume names, e.g., room names, texture and object names such as labels and resource file names, and document file name and content, e.g., from a PowerPoint® document displayed in the environment. Using metadata from the environment that is within a reasonable proximity of the advertisement location is another way that relevant metadata can be extracted from the 3D environment. For example, metadata contained in the virtual “room” that the advertisement is in can be used to populate the HTML document that contains the advertisement. Having the HTML document sufficiently populated with metadata ensures that the advertising server supplies advertisements that are relevant to the context of the region of 3D environment where the advertisement is to be placed. In addition to matching keywords as explained above, advertising content providers may also specify that they only want to target users in a particular geographic region. In this instance, the IP address of the web client, such as a web browser is mapped to a location. The HTML document constructed by the present invention for the advertisement is rendered on the web client. Thus the advertisement runs on the web client; resulting in the IP address of the web client being exposed to the advertisement content provider. This allows the provider to target its ads to specific geographic regions as identified by the web client's IP address.

Additional metadata information that can be collected and rendered into the HTML document holding the advertisement can be derived from information about the avatars in the virtual room, such as, for example, avatar names, corporations, key words taken from text messages, or web pages associated with the virtual environment client 20. The author of the 3D content can also manually add additional metadata to the 3D environment that could be extracted and used.

The 3D engine allocates a web renderer program to be applied to the surface space that was created at step S30 (step S36). The advertisement engine generates an HTML page to contain the advertisement insertion HTML (step S38). The HTML document containing the advertisement is retrieved by the virtual environment engine from the advertisement server. The web rendering program renders the generated page including the advertisement from the advertisement server within the generated space (step S40). When a user is viewing the 2D advertisement being displayed in the 3D virtual environment, the user's point-of-view (“POV”) is translated into a mouse roll-over event for the web renderer (step S42). In other words, when the user is looking at the advertisement in the virtual environment, this is equivalent to the user rolling their mouse curser over the advertisement to activate any events should the advertisement include and support any roll-over events. In one embodiment, if the user clicks their mouse on the advertisement (step S44), a new browser page or tab is constructed containing the advertisement (step S46). In this fashion, the user can view the advertisement on a separate page or tab so as not to disrupt the advertisement rendering in the 3D environment.

The present invention can also provide a mechanism to translate gestures in the 3D environment into 2D mouse gestures on the advertisement. In one embodiment, this is accomplished by marking the center of the user's POV with a target, e.g., a crosshair so a user can see what is going to map to the mouse rollover. Thus, POV changes, from the user's perspective, are seamlessly mapped to 2D mouse locations.

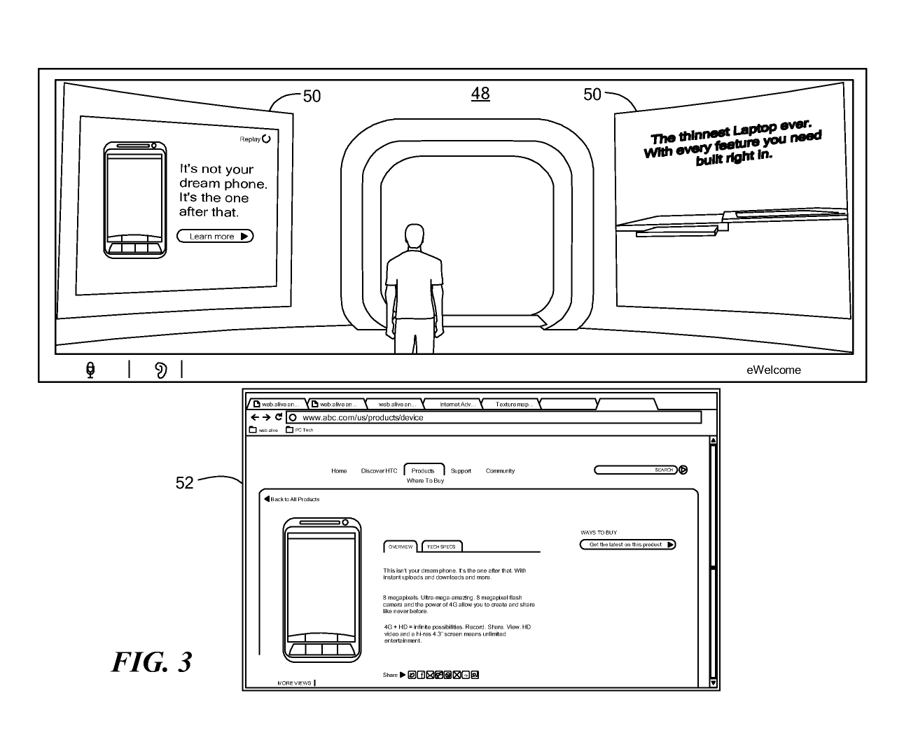

FIG. 3 shows an exemplary view of a 3D virtual environment containing a 2D advertisement in accordance with the present invention. A virtual environment includes a 3D image or region 48. One or more 2D banner advertisements 50 are placed within region 48 in the manner discussed above. The 2D advertisement may be projected on the screen such that it appears on, for example, a 3D billboard within the virtual 3D image 48. Advertisement s50 could be, for example, an existing advertisement taken from the web including such advertising serving applications such as Google's AdSense®. The present invention automatically supports alignment and lighting issues that may arise in the 3D virtual environment and to multiplex or transpose any audio that may be associated with the 2D advertisement into the 3D environment's audio system. In one embodiment, when the user navigates away from or uses their input device, e.g., mouse, to click on the banner advertisements 50, this user selection is mapped to a two-dimensional advertising code corresponding to advertisement 50. This advertising code may then launch a new browser tab or page 52 where page 52 contains information related to advertisements 50. The information displayed on page 52 may be the advertisement itself or some other information related to the selected advertisement. This allows the user to view the advertisements 50 or information related to the advertisements 50 in a separate page so there is no disruption of the advertisement rendering in the 3D environment. The present invention translates 3D environment metadata, i.e., information about the type of environment, its purpose, etc., into a searchable web page such that the page can be scanned for keywords by the advertising provider.

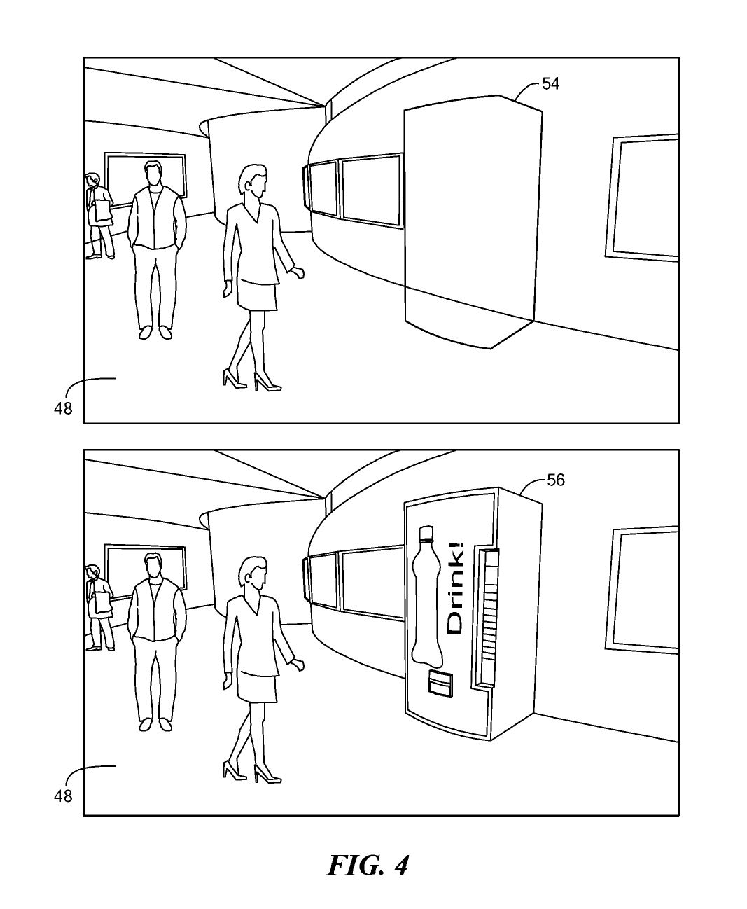

FIG. 4 illustrates an alternate embodiment of the present invention. In this embodiment, 3D advertisements, rather than 2D banner ads, are placed within the 3D virtual environment. Different 3D advertisements can dynamically replace existing ads upon, for example, the occurrence of an event. In this embodiment, a rectangular space 54 is allocated within the 3D environment 48. Space 54 is selected from one of any number of possible dimensions and need not be of the shape and dimension as shown in FIG. 4. For example, space 54 can be a rectangle, square or some other odd-shaped polygon.

A reference object is inserted into the 3D environment that loads a script from a 3D advertisement server. The script is responsible for determining the context of the space within the virtual environment near where 3D advertising content 56 is to be placed and loading 3D advertising content 56 having behavior patterns related to the context of the allocated space 54. For example, 3D advertising content 56 may include animation, sound, music and/or video that is related in some way to the context of and near the virtual environment space that is to receive the 3D advertising content 56. The behavior patterns of 3D advertising content 56 can be modified by the occurrence of an event within the region of the 3D virtual environment such as, for example, the appearance of an avatar within the region. The virtual environment engine then renders 3D advertising content 56 and its behavior patterns such that the 3D advertising content 56 appears in space 54.

Another embodiment of the invention uses existing 3D interface technology such as webGL to deliver 3D advertising content. This is accomplished by ensuring that the 3D perspective of the webGL viewport matches the perspective of the 3D virtual environment. This allows avatars within the virtual environment to view different angles of the 3D content. The present invention transparently injects a transform into the webGL perspective matrix that adjusts the perspective set by the advertising provider.

Technologies such as webGL map form a Modeling space where 3D objects are defined, to Screen space where the 3D objects are rendered. A 3D object's geometry is defined in modeling coordinates, which are coordinates that describe the shape of the object. These coordinates are transformed into world coordinates which are global coordinates that take into account other objects within a given scene. The resulting coordinates are then transformed into view coordinates which are a coordinate system that incorporates a virtual camera's view of the scene. A perspective matrix transforms the view coordinates of the 3D object into viewport coordinates, which are the coordinates that describe the camera projection for the scene. Ad rendering system 17 modifies the transformation outlined above by inserting a virtual world transform process into the perspective matrix to allow for the integration of webGL advertisements into a 3D virtual world. The result is an advertisement having 3D webGL content appearing in the virtual environment as if it were a real world window.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A method for placing an advertisement in a virtual environment, the virtual environment containing a predefined space to receive the advertisement, the method comprising:
retrieving a web-based advertisement from an advertisement server;
inserting the web-based advertisement within a trivial document; and
rendering the trivial document within the predefined space of the virtual environment.

2. The method of claim 1, wherein the advertisement is a two-dimensional advertisement and the virtual environment is a three-dimensional virtual environment.

3. The method of claim 2, the virtual environment containing metadata, the method further comprising translating the metadata into a searchable web page.

4. The method of claim 1, further comprising:
detecting selection of an advertisement;
mapping the selection of the advertisement to an advertising code corresponding to the selected advertisement; and
launching a web page related to the advertisement.

5. The method of claim 4, further comprising mapping changes in a viewer's point-of-view (POV) to motion of the computer input device.

6. The method of claim 2, wherein the advertisement contains a three-dimensional object, the three-dimensional object defined in modeling coordinates, the method further comprising:
transforming the modeling coordinates of the three-dimensional object into virtual world coordinates;
transforming the virtual world coordinates into view coordinates; and
transforming the view coordinates to viewport coordinates.

7. The method of claim 6, further comprising inserting a virtual world transform process to facilitate integration of the advertisement into the virtual environment.

8. The method of claim 3, further comprising:
accessing the metadata from the virtual environment; and
using the metadata to select the advertisement.

9. A system for placing a two-dimensional advertisement in a three-dimensional virtual environment, the advertisement stored on an advertisement server, the system comprising:
a three-dimensional (3D) virtual environment engine adapted to define a space within the virtual environment to receive the advertisement, retrieve a web-based advertisement and insert the web-based advertisement within a trivial document; and
a 3D web renderer operating to render the trivial document containing the advertisement within the predefined space of the virtual environment.

10. The system of claim 9, wherein the virtual environment contains metadata, wherein the 3D engine translates the metadata into a searchable web page.

11. The system of claim 9, wherein elements of the advertisement are made active when the advertisement appears in a virtual environment viewer's point-of-view (POV).

12. The system of claim 9, wherein the advertisement is displayed as a web page when a virtual environment viewer uses a computer input device to select the advertisement.

13. The system of claim 10, wherein the metadata from the virtual environment is used to select the advertisement.

14. A method for placing first three-dimensional (3D) advertising content in a three-dimensional virtual environment, the method comprising:
allocating a 3D space within the virtual environment to receive the first advertising content;
retrieving a script, the script determining a context of the 3D space;
receiving the first advertising content, the first advertising content corresponding to the context of the 3D space; and
rendering the first advertising content within the 3D space.

15. The method of claim 14, further comprising making available to the advertising provider information about the context of the 3D space such that an advertising provider can provide the first advertising content having a behavioral pattern corresponding to the context of the 3D space.

16. The method of claim 14, wherein the first advertising content contains a three-dimensional object, the three-dimensional object defined in modeling coordinates, the method further comprising:
transforming the modeling coordinates of the three-dimensional object into virtual world coordinates;
transforming the virtual world coordinates into view coordinates; and
transforming the view coordinates to viewport coordinates.

17. The method of claim 16, further comprising inserting a virtual world transform process to facilitate integration of the first advertising content into the virtual environment.

18. The method of claim 15, wherein the behavior pattern of the first advertising content within the 3D space is modified by an occurrence of an event within a specific region of the virtual environment.

19. The method of claim 18, wherein the event is an appearance of an avatar within the specific region.

20. The method of claim 18, wherein the first advertising content is replaced by second advertising content upon the occurrence of the event.
